(19) United States
(12) Patent Application Publication
(10) Pub. No.: US 2015/0334663 A1
(43) Pub. Date: Nov. 19, 2015

(54) RADIO TERMINAL APPARATUS, BASE STATION APPARATUS, AND RADIO COMMUNICATION CONTROL METHOD

(71) Applicants: PANASONIC MOBILE COMMUNICATIONS CO., LTD., Kanagawa (JP); NTT DOCOMO, INC, Tokyo (JP)

(72) Inventors: Shinji Ueda, Kanagawa (JP); Hidetoshi Suzuki, Tokyo (JP); Hiromasa Umeda, Tokyo (JP)

(21) Appl. No.: 14/655,679

(22) PCT Filed: Jan. 16, 2014
(86) PCT No.: PCT/JP2014/000198

§ 371 Date: Jun. 25, 2015

(30) Foreign Application Priority Data
Jan. 18, 2013 (JP) 2013-006835

(51) Int. Cl. H04W 52/18; H04W 72/04; H04W 24/02; H04W 24/08

(52) U.S. Cl. CPC H04W 52/18; H04W 24/08; H04W 72/0473; H04W 24/02; H04W 88/02

(57) ABSTRACT

A radio terminal apparatus is provided. When the radio terminal apparatus simultaneously transmits a plurality of modulated waves having different frequencies, the radio terminal apparatus can effectively suppress intermodulation distortions without excessively reducing the transmission powers. This radio terminal apparatus, which is an apparatus for simultaneously transmitting a plurality of modulated waves having different frequencies, comprises a transmission control unit (20). The transmission control unit (20) comprises a transmission power adjustment unit (211) that adjusts the transmission power of a modulated wave existing in proximity to an intermodulation distortion included in a predetermined protected band such that the transmission power is smaller than the transmission powers of the other modulated waves.

### TECHNICAL FIELD

The present invention relates to a radio terminal apparatus, a base station apparatus and a radio communication control method that carry out communication simultaneously using a plurality of modulated waves with different frequencies.

### BACKGROUND ART

LTE-Advanced (hereinafter referred to as “LTE-A”) is known as a successor scheme of LTE (Long Term Evolution). LTE-A uses a technique called “carrier aggregation” (hereinafter, referred to as “CA”), which carries out communication simultaneously using a plurality of modulated waves with different frequencies (e.g., see Non-Patent Literature (hereinafter, referred to as “NPL”) 1). A modulated wave used in CA is called a “component carrier” (hereinafter, referred to as “CC”).

When a radio terminal apparatus transmits a plurality of CCs with different frequencies, inter-modulation distortion (hereinafter, referred to as “IMD”) may occur between CCs due to non-linearity of the transmission circuit. This IMD becomes interference to other radio communication carried out by the terminal apparatus or another apparatus.

Thus, a mechanism for suppressing IMD is under study with regard to the linearity of transmission circuits compatible with conventional communication schemes such as WCDMA (Wideband Code Division Multiple Access) (registered trademark). As this mechanism, for example, MPR (Maximum Power Reduction) and A-MPR (Additional-Maximum Power Reduction) introduced to LTE are known (e.g., see NPL 2). MPR is a technique for uniformly reducing the maximum transmission power in each frequency band based on transmission conditions of transmission signals (e.g., modulation scheme and bandwidth or the like). A-MPR is a technique for reducing the maximum transmission power in addition to MPR to satisfy an unnecessary emission level definition unique to a specific frequency band indicated from a base station. Hereinafter, MPR will refer to a technique for reducing the maximum transmission power using the above-described MPR and A-MPR together.

### CITATION LIST

### Non Patent Literature

### NPL 1

3GPP TR36.912 V9.3.0 “Feasibility study for Further Advancements for E-UTRA (LTE-Advanced)”

### NPL 2

3GPP TS36.101V9.13.0 “Evolved Universal Terrestrial Radio Access (E-UTRA); User Equipment (UE) radio transmission and reception”

### SUMMARY OF INVENTION

### Technical Problem

Since LTE-A uses multicarrier transmission, the maximum transmission power of a radio terminal apparatus is defined as total power of a plurality of CCs. Thus, when MPR which is effective for LTE using single carrier transmission is applied to LTE-A, the following problem arises. This problem will be described with a specific example using FIG. 1 and FIG. 2.

Here, a case will be described as an example where a radio terminal apparatus transmits CC1 with frequency f1 and CC2 with frequency f2 simultaneously. In this case, due to non-linearity of a transmission circuit of the radio terminal apparatus, IMD1 is generated at frequency 2f1−f2 and IMD2 is generated at frequency 2f2−f1 as a cubic IMD. An image of this case is shown in FIG. 1.

FIG. 1 illustrates a situation in which IMDs 1 and 2 are generated when the transmission power of CC1 is equal to the transmission power of CC2. In FIG. 1, IMD1 is generated in the vicinity of CC1 and IMD2 is generated in the vicinity of CC2. Note that in FIG. 1, f1 and f2 represent center frequencies of CC1 and CC2, respectively. In FIG. 1, b1 and b2 represent bandwidths of CC1 and CC2, respectively.

As shown in FIG. 1, when, for example, IMD2 of the two IMDs enters a protected band shown by a broken line, the level of this IMD2 needs to be suppressed to a defined level or lower. Note that the term “protected band” refers to a value defined by law or standard, or a value based on a radio communication environment of the terminal apparatus.

Here, an example will be described where the total maximum transmission power of CC1 and CC2 (hereinafter simply referred to as “maximum transmission power”) is reduced by 3 dB by applying MPR to suppress IMD2. Here, an assumption is made that the level of IMD2 exceeds a defined level of the protected band by 9 dB. In this case, for example, when the maximum transmission power defined by standard is reduced by 3 dB with respect to 23 dBm, the maximum transmission power is 20 dBm. Assuming that transmission power of CC1 and transmission power of CC2 are each 20 dBm, as a result of reduction by 3 dB, transmission power of CC1 and transmission power of CC2 each become 17 dBm.

Thus, when the maximum transmission power is suppressed by 3 dB, the level of IMD2 is suppressed by 9 dB which is equal to multiplication of 3 dB by 3. This allows the defined level of the protected band to be satisfied.

Next, a case will be described as an example with reference to FIG. 2 where transmission power of CC2 is smaller than transmission power of CC1.

In FIG. 2, suppose that transmission power of CC2 is lower than transmission power of CC1 by 3 dB. In this case, the level of IMD2 is lower by 6 dB which is equal to multiplication of 3 dB by 2. The total transmission power is the sum of true values of 20 dBm and 17 dBm, which is 21.8 dBm.

Here, MPR is applied as in the case of FIG. 1. Since the transmission power exceeds maximum transmission power 20 dBm using MPR 3 dB by 1.8 dB, maximum transmission power is set to 20 dBm by reducing the transmission power of CC1 and transmission power of CC2 by 1.8 dB respectively. In this case, the level of IMD2 is further suppressed by 1.8×3=5.4 dB from an initial state which is lower by 6 dB and is consequently suppressed by 11.4 dB. That is, this means that IMD2 is suppressed excessively and the maximum transmission power is reduced excessively.

In this way, when there is a difference between the transmission power of CC1 and transmission power of CC2, application of MPR may cause a problem that the maximum transmission power is reduced more than necessary. As a result, the communicable distance between the radio terminal apparatus and the base station apparatus becomes shorter.

An object of the present invention is to effectively suppress inter-modulation distortion without reducing transmission power more than necessary during simultaneous transmission of a plurality of modulated waves with different frequencies.

### Solution to Problem

A radio terminal apparatus according to an aspect of the present invention is an apparatus that simultaneously transmits a plurality of modulated waves with different frequencies, the apparatus including a transmission power adjustment section that adjusts transmission power of a modulated wave located in a vicinity of inter-modulation distortion included in a predetermined protected band such that the transmission power is smaller than transmission power of another modulated wave.

A base station apparatus according to an aspect of the present invention is an apparatus that performs communication with a radio terminal apparatus that simultaneously transmits a plurality of modulated waves with different frequencies, in which the base station apparatus instructs the radio terminal apparatus to perform control of reducing at least one of transmission power of a modulated wave located in a vicinity of inter-modulation distortion included in a predetermined protected-band and a power spectral density of the modulated wave in order to suppress inter-modulation distortion.

A radio terminal apparatus according to an aspect of the present invention is an apparatus that simultaneously transmits a plurality of modulated waves with different frequencies to the base station apparatus according to an aspect of the present invention, in which the radio terminal apparatus performs control of reducing at least one of transmission power of a modulated wave located in the vicinity of inter-modulation distortion included in a predetermined protected band and a power spectral density of the modulated wave in order to suppress inter-modulation distortion based on the instruction received from the base station apparatus.

A radio communication control method according to an aspect of the present invention is a method for simultaneously transmitting a plurality of modulated waves with different frequencies, the method including adjusting transmission power of a modulated wave located in a vicinity of inter-modulation distortion included in a predetermined protected band such that the transmission power is smaller than transmission power of another modulated wave.

### Advantageous Effects of Invention

According to the present invention, inter-modulation distortion can be effectively suppressed without reducing transmission power more than necessary during simultaneous transmission of a plurality of modulated waves with different frequencies.

### BRIEF DESCRIPTION OF DRAWINGS

FIG. 1 is a diagram illustrating an example of CC and IMD;

FIG. 2 is a diagram illustrating another example of CC and IMD;

FIG. 3 is a block diagram illustrating a configuration example of a radio terminal apparatus according to Embodiment 1 of the present invention;

FIG. 4 is a block diagram illustrating a configuration example of a transmission control section of the radio terminal apparatus according to Embodiment 1 of the present invention;

FIG. 5 is a flowchart illustrating an operation example of the radio terminal apparatus according to Embodiment 1 of the present invention;

FIG. 6 is a block diagram illustrating a configuration example of a transmission control section of a radio terminal apparatus according to Embodiment 2 of the present invention; and

FIG. 7 is a block diagram illustrating a configuration example of a radio terminal apparatus and a base station apparatus according to Embodiment 3 of the present invention.

### DESCRIPTION OF EMBODIMENTS

Hereinafter, embodiments of the present invention will be described in detail with reference to the accompanying drawings.

### Embodiment 1

Embodiment 1 will be described.

<Configuration of Radio Terminal Apparatus 100>

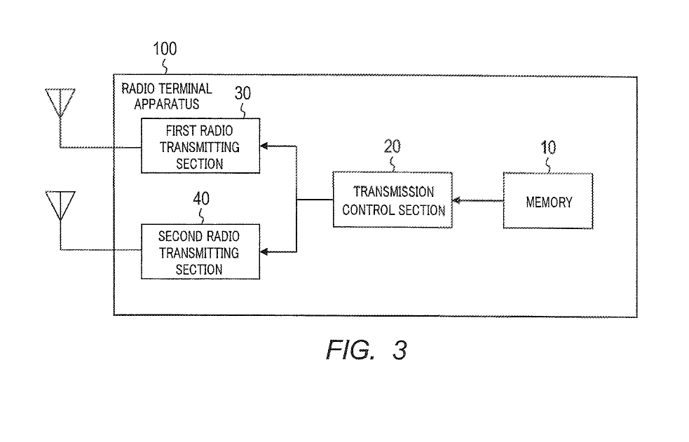

A configuration of a radio terminal apparatus according to Embodiment 1 of the present invention will be described using FIG. 3. FIG. 3 is a block diagram illustrating a configuration example of radio terminal apparatus 100 of the present embodiment.

In FIG. 3, radio terminal apparatus 100 includes memory 10, transmission control section 20, first radio transmitting section 30, and second radio transmitting section 40. Radio terminal apparatus 100 is applicable to a mobile terminal such as a smartphone, tablet, personal computer or the like.

Memory 10 stores various kinds of data (hereinafter referred to as “control parameters”) used for processing carried out by transmission control section 20. Memory 10 sends the control parameters to transmission control section 20.

Transmission control section 20 receives the control parameters from memory 10. Next, transmission control section 20 determines the transmission power, frequency, bandwidth, and modulation scheme for each CC based on the control parameters. Next, transmission control section 20 sends a radio control signal indicating the result determined for respective CCs to first radio transmitting section 30 and second radio transmitting section 40. Transmission control section 20 receives IQ data of each CC from memory 10. Transmission control section 20 then sends the IQ data of respective CCs to first radio transmitting section 30 and second radio transmitting section 40.

First radio transmitting section 30 receives the IQ data of CC1 and a radio control signal of CC1 from transmission control section 20. Next, first radio transmitting section 30 generates a radio transmission signal based on the IQ data and the radio control signal. Next, first radio transmitting section 30 applies power amplification to the generated radio transmission signal and transmits the radio transmission signal from an antenna.

Second radio transmitting section 40 performs operation similar to that of first radio transmitting section 30 on CC2. Therefore, the description of the operation will be omitted.

FIG. 3 shows a case where transmission control section 20 receives a control parameter or IQ data from memory 10, but the control parameter or IQ data may also be received from a place other than memory 10.

<Configuration of Transmission Control Section 20>

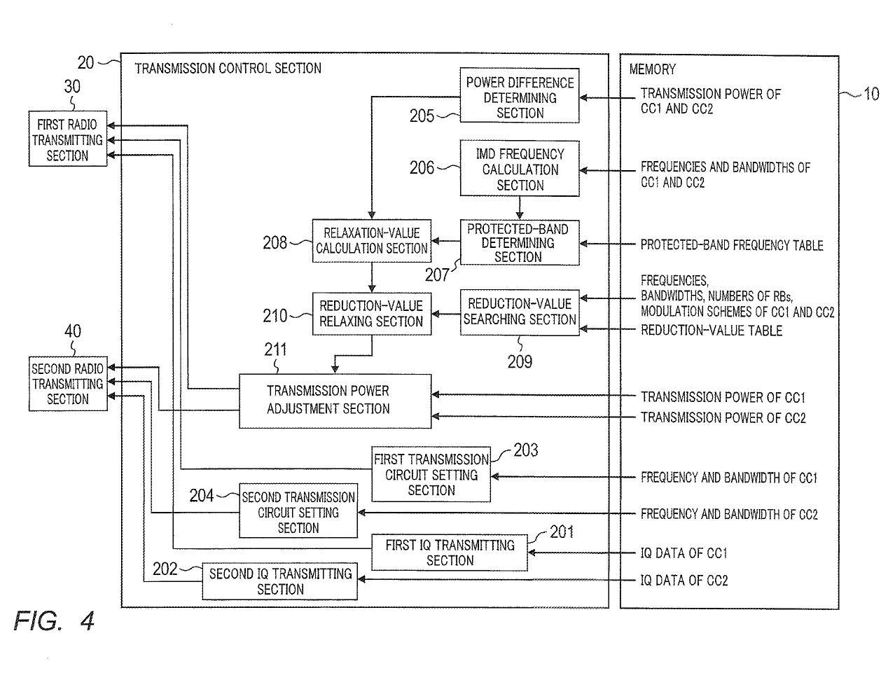

Next, a configuration of transmission control section 20 of the present embodiment will be described using FIG. 4. FIG. 4 is a block diagram illustrating a configuration example of transmission control section 20 of the present embodiment.

In FIG. 4, transmission control section 10 includes first IQ transmitting section 201, second IQ transmitting section 202, first transmission circuit setting section 203, second transmission circuit setting section 204, power difference determining section 205, IMD frequency calculation section 206, protected-band determining section 207, relaxation-value calculation section 208, Reduction-value searching section 209, reduction-value relaxing section 210, and transmission power adjustment section 211.

Upon receiving the IQ data of CC1 from memory 10, first IQ transmitting section 201 sends the IQ data to first radio transmitting section 30.

Upon receiving the IQ data of CC2 from memory 10, second IQ transmitting section 202 sends the IQ data to second radio transmitting section 40.

First transmission circuit setting section 203 receives a frequency and bandwidth of CC1 as control parameters from memory 10. Next, first transmission circuit setting section 203 sets a circuit of first radio transmitting section 30 based on the received frequency and bandwidth. The setting of the circuit is as follows, for example. That is, first transmission circuit setting section 203 sets an oscillating frequency of a synthesizer of first radio transmitting section 30 based on the received frequency. First transmission circuit setting section 203 switches a sampling rate of a DA (Digital Analog) converter and a pass bandwidth of an anti-aliasing filter of first radio transmitting section 30 based on the received bandwidth.

Second transmission circuit setting section 204 receives a frequency and bandwidth of CC2 as control parameters from memory 10. Next, second transmission circuit setting section 204 makes a circuit setting of second radio transmitting section 40 based on the received frequency and bandwidth. This setting example is the same as that of aforementioned first transmission circuit setting section 203.

Power difference determining section 205 receives transmission power of CC1 and transmission power of CC2 as control parameters from memory 10. Next, power difference determining section 205 determines which one of transmission power of CC1 and transmission power of CC2 is smaller and by what degree. Power difference determining section 205 sends information indicating the determination result (hereinafter referred to as “power difference determination information”) to relaxation-value calculation section 208.

IMD frequency calculation section 206 receives the frequency and bandwidth of CC1 and the frequency and bandwidth of CC2 as control parameters from memory 10. Next, IMD frequency calculation section 206 calculates the frequency of IMD that occurs based on the frequency and bandwidth of CC1 and the frequency and bandwidth of CC2. Here, a calculation example will be described below.

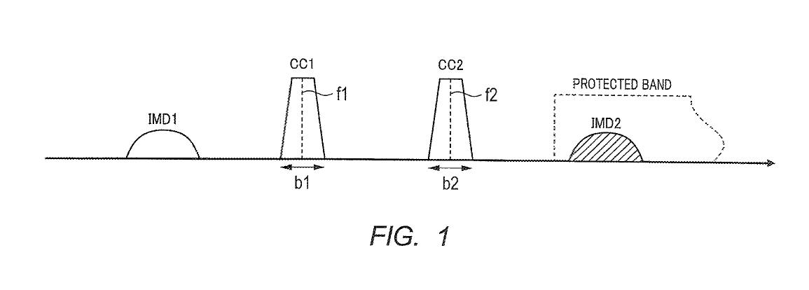

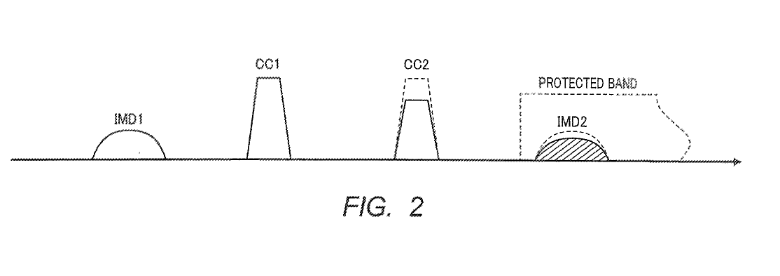

The example shown in aforementioned FIG. 1 or FIG. 2 is used for describing the calculation example. That is, suppose that a center frequency of CC1 is f1, a center frequency of CC2 is f2, a bandwidth of CC1 is b1, and a bandwidth of CC2 is b2. IMD frequency calculation section 206 carries out calculations when the degree of IMD is a cubic as shown below.

IMD1=2f1−f2−(2b1+b2)/2 to 2f1−f2+(2b1+b2)/2

IMD2=2f2−f1−(2b2+b1)/2 to 2f2−f1+(2b2+b1)/2

IMD frequency calculation section 206 also carries out calculations when the degree of IMD is quintic as shown below.

IMD3=3f1−f2−(3b1+2b2)/2 to 3f1−2f2+(3b1+2b2)/2

IMD4=3f2−2f1−(3b2+2b1)/2 to 3f2−2f1+(3b2+2b1)/2

For example, when f1=1925 MHz, f2=1970 MHz, b1=10 MHz, b2=20 MHz, results of the above calculations are as follows.

IMD1=1860 MHz to 1900 MHz

IMD2=1990 MHz to 2040 MHz

IMD3=1800 MHz to 1870 MHz

IMD4=2020 MHz to 2100 MHz

IMD frequency calculation section 206 sends the frequencies of IMDs 1 to 4 calculated as described above to protected-band determining section 207. In this case, IMD frequency calculation section 206 also sends the frequency of CC1 and frequency of CC2 to protected-band determining section 207.

Protected-band determining section 207 receives the frequencies of IMDs 1 to 4 and the frequency of CC1 and frequency of CC2 from IMD frequency calculation section 206. Next, protected-band determining section 207 reads a protected-band frequency table stored in memory 10. The protected-band frequency table is a table indicating predetermined frequencies of the protected band.

Protected-band determining section 207 first determines whether or not one of the frequencies of IMDs 1 to 4 is included in the frequencies of the protected band. When the determination result shows that none of the frequencies of IMDs 1 to 4 is included in the frequencies of the protected band, protected-band determining section 207 sends information indicating the fact (hereinafter referred to as “protected-band determination information A”) to relaxation-value calculation section 208. On the other hand, when the determination result shows that one of the frequencies of IMDs 1 to 4 is included in the frequencies of the protected band, protected-band determining section 207 compares the frequency of IMD included in the frequencies of the protected band with the frequency of CC1 and the frequency of CC2. Protected-band determining section 207 determines, in the vicinity of which of CC1 or CC2, IMD included in the frequencies of the protected band is located, based on this comparison. Protected-band determining section 207 then sends the protected-band determination information B to relaxation-value calculation section 208. Protected-band determination information B is information indicating which of IMDs 1 to 4 is the IMD included in the frequencies of the protected band, which of CC1 or CC2 is the CC located in the vicinity of the IMD included in the frequencies of the protected band and the degree of the IMD included in the frequencies of the protected band.

Relaxation-value calculation section 208 receives power difference determination information from power difference determining section 205 and receives protected-band determination information A or protected-band determination information B from protected-band determining section 207.

Here, upon receiving protected-band determination information A, relaxation-value calculation section 208 determines the relaxation value to be 0 and sends the relaxation value to reduction-value relaxing section 210.

On the other hand, upon receiving protected-band determination information B, relaxation-value calculation section 208 determines whether or not transmission power of the CC in the vicinity of IMD included in the frequencies of the protected band is lower than that of the other CC based on the power difference determination information and protected-band determination information B. When the determination result shows that the transmission power of the CC in the vicinity of IMD included in the frequencies of the protected band is not lower than the transmission power of the other CC, relaxation-value calculation section 208 determines the relaxation value to be 0 and sends the relaxation value to reduction-value relaxing section 210. On the other hand, when the determination result shows that the transmission power of the CC in the vicinity of IMD included in the frequencies of the protected band is lower than the transmission power of the other CC, relaxation-value calculation section 208 calculates a relaxation value. That is, relaxation-value calculation section 208 calculates the relaxation value based on the power difference indicated by the power difference determination information and the degree of IMD indicated by protected-band determination information B. The relaxation value is a value for relaxing the reduction value which will be described later. The equation for calculating the relaxation value differs depending on the degree of IMD indicated by protected-band determination information B.

For example, when IMD included in the frequencies of the protected band is located in the vicinity of CC2 and transmission power P2 of CC2 is lower by ΔP than transmission power P1 of CC1, the relaxation value is calculated according to the degree of IMD as shown below.

The calculation when the degree of IMD is cubic will be described first.

When P1−P2=ΔP,

P1=Pmax−10 log 10(1+10̂(−ΔP/10))

P2=P1−ΔP. In this case, IMD is Q′=Q+{P1−(Pmax−3)}+2*{P2−(Pmax−3)}

=Q+(P1+2P2)−3(Pmax−3)

=Q+3P1−2ΔP−3(Pmax−3)

In the expressions, Q is IMD when P1=P2=Pmax−3 dB.

Moreover, ⅓ of the amount of change of IMD becomes the relaxation value. Therefore, relaxation value ΔX becomes as follows,

$$\begin{matrix}Δ X = ( Q - {Q}^{′} ) / 3 \\ = 2 Δ P / 3 - P 1 + ( P max - 3 ) \\ = 2 Δ P / 3 - ( 3 + P 1 - P max ) \\ = 2 Δ P / 3 - \{ 3 - 10 log 10 ( 1 + 10 \hat{} ( - Δ P / 10 ) ) \}\end{matrix}$$

Next, the calculation when the degree of IMD is quintic will be described.

$$\begin{matrix}{Q}^{′} = Q + ( 2 P 1 + 3 P 2 ) - 5 ( P max - 3 ) \\ = Q + 5 P 1 - 3 Δ P - 5 ( P max - 3 )\end{matrix}$$

$$\begin{matrix}Δ X = ( Q - {Q}^{′} ) / 5 \\ = 3 Δ P / 5 - P 1 + ( P max - 3 ) \\ = 3 Δ P / 5 - \{ 3 - 10 log 10 ( 1 + 10 \hat{} ( - Δ P / 10 ) ) \}\end{matrix}$$

In the above-described equations, coefficients such as ⅔ or ⅗ are assumed to have been calculated in advance based on theoretical characteristics of IMD, but the coefficients are not limited to this. The above-described coefficients may also be adjusted based on the actual characteristics of the device. The above-described equations may be approximate equations using a linear function or values may be stored in a lookup table and the values may be referenced.

Relaxation-value calculation section 208 sends the relaxation value calculated using the above-described equations to reduction-value relaxing section 210.

Reduction-value searching section 209 receives transmission conditions regarding CC1 and CC2, that is, frequency, bandwidth, number of RBs (Resource Blocks) and modulation scheme from memory 10 as control parameters. Reduction-value searching section 209 also reads a reduction-value table from memory 10. The reduction-value table is a table in which a reduction value is predetermined according to a frequency, bandwidth, number of RBs, and modulation scheme. The reduction value is a value to reduce the maximum transmission power, and examples of the reduction value include values used in MPR or A-MPR.

Reduction-value searching section 209 searches for a reduction value corresponding to the frequency, bandwidth, number of RBs, and modulation scheme received from the reduction-value table as control parameters. Reduction-value searching section 209 sends the found reduction value to reduction-value relaxing section 210.

Reduction-value relaxing section 210 receives the relaxation value from relaxation-value calculation section 208 and receives the reduction value from reduction-value searching section 209. Reduction-value relaxing section 210 subtracts the relaxation value from the reduction value. The reduction value is thereby relaxed. The value resulting from the subtraction is hereinafter referred to as “relaxed reduction value.” Note that when the subtraction result becomes a negative number, reduction-value relaxing section 210 determines the relaxed reduction value to be 0. Reduction-value relaxing section 210 then sends the relaxed reduction value to transmission power adjustment section 211.

Transmission power adjustment section 211 receives the relaxed reduction value from reduction-value relaxing section 210. Transmission power adjustment section 211 adjusts the maximum transmission power using the relaxed reduction value. This adjustment result is called “limit value.” The maximum transmission power referred to here is a value defined by law or standard or a value based on a radio communication environment of radio terminal apparatus 100.

Transmission power adjustment section 211 receives transmission power of CC1 and transmission power of CC2 as control parameters from memory 10. Transmission power adjustment section 211 then adds up transmission power of CC1 and transmission power of CC2 as power necessary for radio terminal apparatus 100 to perform radio transmission. This calculation result is called “total transmission power.”

Transmission power adjustment section 211 then determines whether or not the total transmission power is greater than a limit value. When the determination result shows that the total transmission power is not greater than the limit value, transmission power adjustment section 211 notifies the radio transmitting section of transmission power of each CC received from memory 10 as a control parameter. That is, transmission power adjustment section 211 sends a radio control signal indicating the transmission power of CC1 received from memory 10 to first radio transmitting section 30 and sends a radio control signal indicating transmission power of CC2 received from memory 10 to second radio transmitting section 40. On the other hand, when the determination result shows that the total transmission power is greater than the limit value, transmission power adjustment section 211 subtracts the limit value from the total transmission power, thereby calculating a value by which the total transmission power exceeds the limit value (hereinafter referred to as “excess value”). Transmission power adjustment section 211 then subtracts the excess value from each CC received as a control parameter from memory 10. In this way, transmission power of CC1 and transmission power of CC2 are each adjusted. Transmission power adjustment section 211 sends a radio control signal indicating the adjusted transmission power of CC1 to first radio transmitting section 30 and sends a radio control signal indicating the adjusted transmission power of CC2 to second radio transmitting section 40.

<Operation of Radio Terminal Apparatus 100>

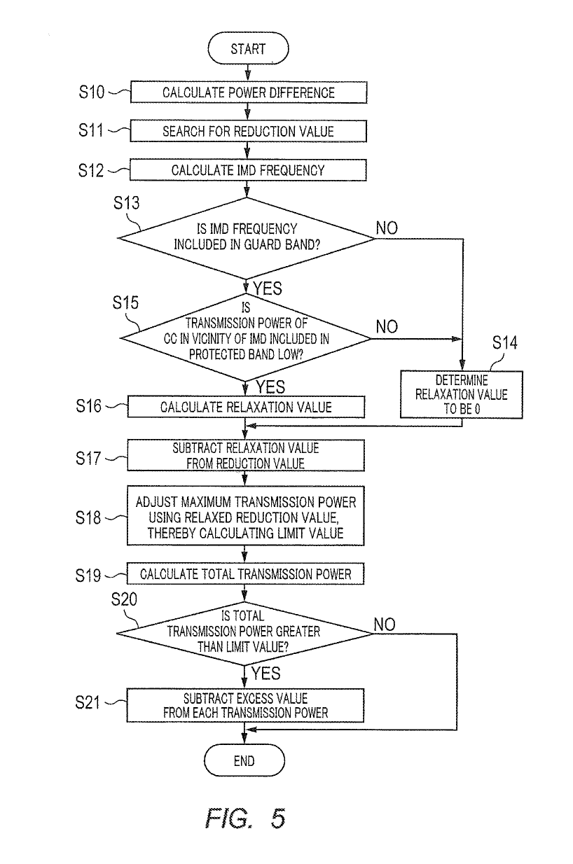

Next, an operation example of radio terminal apparatus 100 will be described. FIG. 5 is a flowchart illustrating an operation example of radio terminal apparatus 100 of the present embodiment. The operation example in FIG. 5 is an adjustment operation of transmission power performed by transmission control section 20.

In step S10, power difference determining section 205 determines which of transmission power of CC1 or transmission power of CC2 is smaller and by what degree based on the transmission power of CC1 and the transmission power of CC2 received as control parameters. Power difference determining section 205 sends power difference determination information indicating the determination result to relaxation-value calculation section 208.

In step S11, reduction-value searching section 209 searches for a reduction value corresponding to transmission conditions (frequency, bandwidth, number of RBs and modulation scheme) of CC1 and CC2 received as control parameters from the reduction-value table. Reduction-value searching section 209 then sends the searched reduction value to reduction-value relaxing section 210.

In step S12, IMD frequency calculation section 206 calculates a frequency of IMD generated based on the respective frequencies and bandwidths of CC1 and CC2 received as control parameters. Here, IMD frequency calculation section 206 calculates the frequency according to the degree of IMD (e.g., cubic and quintic). That is, IMD frequency calculation section 206 calculates frequencies of cubic IMD1 and 2 and quintic IMD3 and 4 respectively. IMD frequency calculation section 206 then sends the frequencies of IMD1 to 4 together with the frequency of CC1 and the frequency of CC2 to protected-band determining section 207.

In step S13, protected-band determining section 207 receives the frequencies of IMD1 to 4 from IMD frequency calculation section 206 and determines whether or not one of the frequencies is included in the predetermined frequencies of the protected band.

When the determination result in step S13 shows that none of the frequencies of IMD1 to 4 is included in the frequencies of the protected band (step S13: NO), the flow proceeds to step S14. In this case, protected-band determining section 207 sends protected-band determination information A to relaxation-value calculation section 208. Protected-band determination information A indicates that no IMD is included in the frequencies of the protected band.

On the other hand, the determination result in step S13 shows that one of the frequencies of IMD1 to 4 is included in the frequencies of the protected band (step S13: YES), the flow proceeds to step S15. In this case, protected-band determining section 207 compares the frequency of IMD included in the frequencies of the protected band with the respective frequencies of CC1 and CC2, thereby determining whether IMD included in the frequencies of the protected band is located in in the vicinity of CC1 or CC2. Protected-band determining section 207 sends protected-band determination information B also reflecting the determination result to relaxation-value calculation section 208. Protected-band determination information B indicates IMD included in the frequencies of the protected band, CC located in the vicinity of IMD and the degree of IMD.

In step S14, upon receiving protected-band determination information A, relaxation-value calculation section 208 determines the relaxation value to be 0. Relaxation-value calculation section 208 then sends the determined relaxation value of 0 to reduction-value relaxing section 210.

In step S15, upon receiving protected-band determination information B, relaxation-value calculation section 208 makes the next determination. That is, relaxation-value calculation section 208 determines whether or not the transmission power of the CC in the vicinity of IMD included in the frequencies of the protected band (hereinafter referred to as “CC in the vicinity of IMD”) is lower than the transmission power of the other CC based on the power difference determination information and protected-band determination information B from power difference determining section 205.

When the determination result in step S15 shows that the transmission power of the CC in the vicinity of IMD is not lower than the transmission power of the other CC (step S15: NO), the flow proceeds to step S14.

On the other hand, when the determination result in step S15 shows that the transmission power of the CC in the vicinity of IMD is lower than the transmission power of the other CC (step S15: YES), the flow proceeds to step S16.

In step S16, relaxation-value calculation section 208 calculates a relaxation value based on a power difference indicated by the power difference determination information and the degree of IMD indicated by protected-band determination information B. Relaxation-value calculation section 208 then sends the relaxation value to reduction-value relaxing section 210.

In step S17, reduction-value relaxing section 210 subtracts the relaxation value received from relaxation-value calculation section 208 from the reduction value received from reduction-value searching section 209 thereby calculating a relaxed reduction value. Here, when the subtraction result becomes a negative number, reduction-value relaxing section 210 determines the relaxed reduction value to be 0. Reduction-value relaxing section 210 then sends the relaxed reduction value to transmission power adjustment section 211.

In step S18, transmission power adjustment section 211 adjusts the maximum transmission power using the relaxed reduction value received from reduction-value relaxing section 210, thereby calculating a limit value.

In step S19, transmission power adjustment section 211 adds up transmission power of CC1 and transmission power of CC2 received as control parameters and calculates total transmission power.

In step S20, transmission power adjustment section 211 determines whether or not the total transmission power is greater than the limit value.

When the determination result in step S20 shows that the total transmission power is not greater than the limit value (step S20: NO), the flow ends. In this case, transmission power adjustment section 211 sends a radio control signal indicating the transmission power of CC1 received as the control parameter to first radio transmitting section 30. Transmission power adjustment section 211 sends a radio control signal indicating the transmission power of CC2 received as the control parameter to second radio transmitting section 40.

When the determination result in step S20 shows that the total transmission power is greater than the limit value (step S20: YES), the flow proceeds to step S21.

In step S21, transmission power adjustment section 211 calculates an excess value based on the total transmission power and the limit value and subtracts the excess value from each CC received as the control parameter. Thus, transmission power of CC1 and transmission power of CC2 are adjusted respectively. Transmission power adjustment section 211 then sends a radio control signal indicating the adjusted transmission power of CC1 to first radio transmitting section 30 and sends a radio control signal indicating the adjusted transmission power of CC2 to second radio transmitting section 40.

As described above, when there is a difference between the transmission power of CC1 and transmission power of CC2 in simultaneous transmission of a plurality of modulated waves with different frequencies, radio terminal apparatus 100 of the present embodiment can effectively suppress inter-modulation distortion without reducing transmission power more than necessary. As a result, radio terminal apparatus 100 can prevent a communicable distance from the base station apparatus from becoming shorter.

In the present embodiment, protected-band determining section 207 sends the degree of IMD to relaxation-value calculation section 208, but the present invention is not limited to this. For example, if it is predetermined that IMD in the predetermined degree should be taken into consideration, relaxation-value calculation section 208 may calculate the relaxation value based on the degree without any need to receive the degree. For example, if it is predetermined that only cubic IMD should be taken into consideration, relaxation-value calculation section 208 may calculate a relaxation value corresponding to a cubic value.

In the present embodiment, IMD frequency calculation section 206 calculates cubic and quintic IMDs, and protected-band determining section 207 determines whether or not cubic and quintic IMDs are included in the protected band respectively, but the present invention is not limited to this. IMD frequency calculation section 206 may further calculate IMDs of other degrees and protected-band determining section 207 may determine whether or not the IMDs are included in the protected band.

In the present embodiment, IMD frequency calculation section 206 calculates all IMDs of different degrees, but the present invention is not limited to this. Since the protected band is defined by law or standard, the positional relationship between the protected band and each CC is known. Therefore, IMD frequency calculation section 206 may calculate only IMDs which may be included in the protected band.

### Embodiment 2

Embodiment 2 of the present invention will be described. In above Embodiment 1, an adjustment is made so as to reduce transmission power of CC1 and CC2 equally, whereas in present Embodiment 2, an adjustment is performed so as to reduce transmission power of CC1 and CC2 by different amounts.

<Configuration of Radio Terminal Apparatus 100>

Since a configuration of radio terminal apparatus 100 according to Embodiment 2 of the present invention is the same as the configuration in FIG. 3 described in Embodiment 1, the description here will not be repeated.

<Configuration of Transmission Control Section 20>

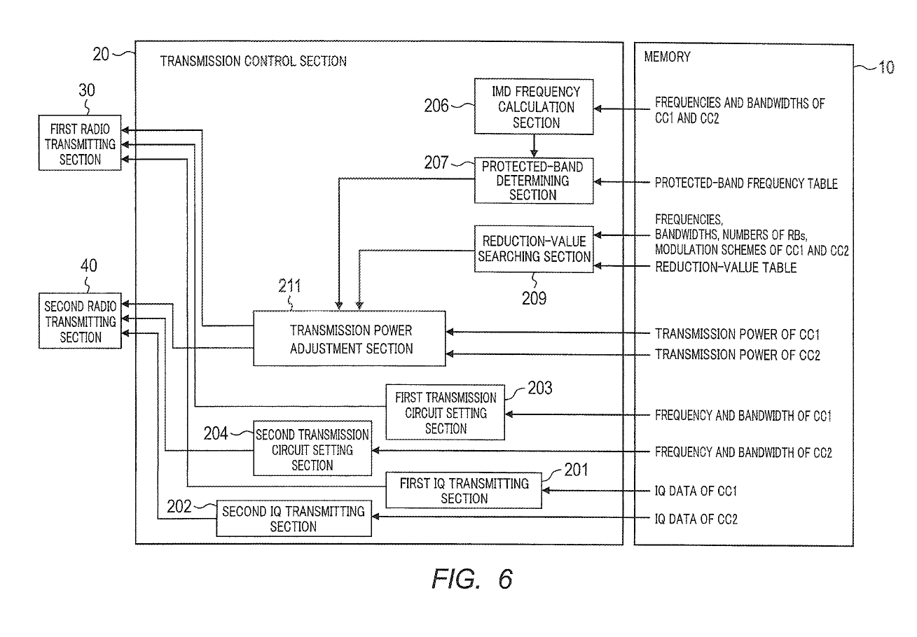

A configuration of transmission control section 20 of the present embodiment will be described using FIG. 6. FIG. 6 is a block diagram illustrating a configuration example of transmission control section 20 of the present embodiment. The description will be given, assuming that the degree of IMD is cubic.

The configuration shown in FIG. 6 is different from the configuration shown in FIG. 4 in that it is provided with none of power difference determining section 205, relaxation-value calculation section 208 or reduction-value relaxing section 210. Since the operation of other than transmission power adjustment section 211 is similar to the operation in Embodiment 1, the description will not be repeated.

Transmission power adjustment section 211 adjusts maximum transmission power using the reduction value from reduction-value searching section 209 and calculates a limit value.

As in the case of aforementioned Embodiment 1, transmission power adjustment section 211 calculates total transmission power, determines whether or not the total transmission power is greater than a limit value and calculates an excess value. After this, transmission power adjustment section 211 performs the following calculations. The following description is given assuming that the excess value is A dB.

Transmission power adjustment section 211 receives a reduction value from Reduction-value searching section 209 and receives protected-band determination information A or protected-band determination information B from protected-band determining section 207.

Here, upon receiving protected-band determination information A, transmission power adjustment section 211 reduces transmission power of CC1 and CC2 by A dB respectively and makes an adjustment so that the total transmission power becomes equal to the adjustment value.

Upon receiving protected-band determination information B, transmission power adjustment section 211 reduces transmission power Px of CC located in the vicinity of IMD included in the frequencies of the protected band (hereinafter referred to as “CC in the vicinity of IMD”) by 2×A (dB) to Px−2A. Transmission power adjustment section 211 obtains transmission power Py of the other CC by subtracting transmission power Px−2A of CC in the vicinity of IMD from the limit value in a true value. In this way, transmission power adjustment section 211 of the present embodiment makes an adjustment by providing a difference in the amount of reduction of transmission power of two CCs.

To simplify the processing, transmission power adjustment section 211 may reduce transmission power Py of the other CC by A/2 (dB).

Transmission power adjustment section 211 may also add an offset, for example, A+1 (dB) to above-described 2A.

Transmission power adjustment section 211 may also refer to a distribution (stored in a table beforehand) of reduction values to be applied to CC1 and CC2 respectively. In that case, transmission power adjustment section 211 selects a reduction value such that the transmission power of the CC in the vicinity of IMD is suppressed more than the transmission power of the other CC.

In this way, radio terminal apparatus 100 of the present embodiment obtains the following effects in addition to the effects of Embodiment 1. That is, radio terminal apparatus 100 of the present embodiment can reduce the transmission power of the CC in the vicinity of IMD more than the transmission power of the other CC compared to Embodiment 1 in which an equal value is subtracted from transmission power of both CCs when MPR is applied. Therefore, when IMD to be suppressed interferes with the received signal of radio terminal apparatus 100 of the present embodiment, radio terminal apparatus 100 can suppress interference power and improve reception performance.

In the present embodiment, the transmission power of both CC1 and CC2 is reduced, but the present invention is not limited to this. For example, when the transmission power of the CC located in the vicinity of IMD is much greater than the transmission power of the other CC, only the power of the CC in the vicinity of IMD may be reduced.

### Embodiment 3

Embodiment 3 of the present invention will be described. In the present embodiment, a base station apparatus determines a control method that should be carried out by a radio terminal apparatus and the radio terminal apparatus executes the control method determined by the base station apparatus. Note that the “control” referred to here in the present embodiment may also be paraphrased as “limit.”

<Configuration of Radio Communication System>

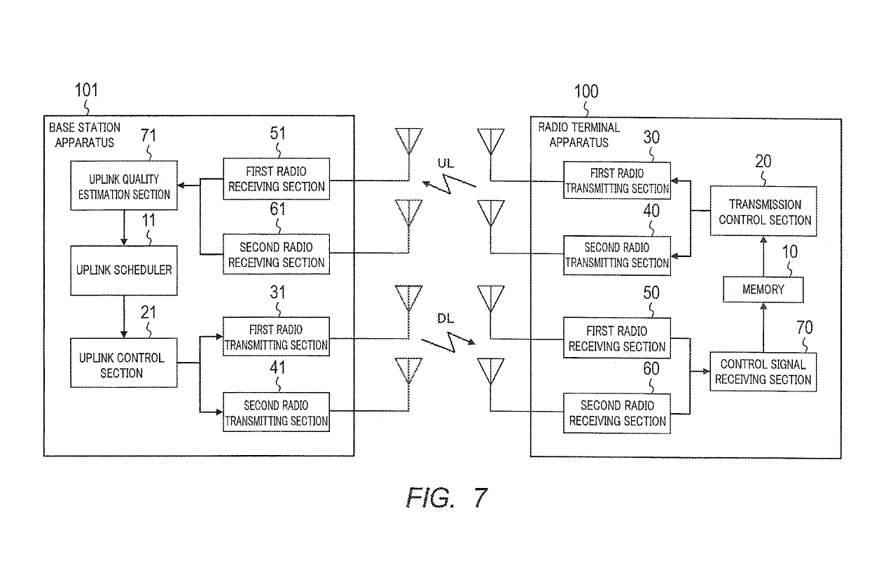

A configuration of a radio communication system according to Embodiment 3 of the present invention will be described. FIG. 7 is a block diagram illustrating a configuration example of a radio communication system of the present embodiment.

In FIG. 7, the radio communication system includes base station apparatus 101 and radio terminal apparatus 100. Base station apparatus 101 and radio terminal apparatus 100 perform radio communication according to, for example, LTE-A.

In FIG. 7, base station apparatus 101 includes first radio receiving section 51, second radio receiving section 61, uplink quality estimation section 71, uplink scheduler 11, uplink control section 21, first radio transmitting section 31, and second radio transmitting section 41.

First radio receiving section 51 and second radio receiving section 61 receive an uplink radio signal from radio terminal apparatus 100 and send the uplink radio signal to uplink quality estimation section 71.

Uplink quality estimation section 71 estimates uplink quality based on the uplink radio signal and notifies the uplink scheduler of the uplink quality. Uplink quality estimation section 71 notifies uplink scheduler 11 of the amount of uplink data requested by radio terminal apparatus 100 (hereinafter referred to as “requested amount of uplink data”).

Uplink scheduler 11 allocates radio resources required for radio transmission carried out by radio terminal apparatus 100 based on uplink channel quality and the requested amount of uplink data. Hereinafter, information indicating this allocation result will be referred to as “resource allocation information.”

Uplink scheduler 11 determines a control method to be carried out by radio terminal apparatus 100 based on the uplink channel quality and the requested amount of uplink data. The control method referred to here is a method for controlling at least one of a bandwidth and transmission power to suppress IMD which may possibly occur between CCs transmitted by radio terminal apparatus 100. Thus, uplink scheduler 11 determines whether radio terminal apparatus 100 controls the bandwidth, controls transmission power or controls both the bandwidth and transmission power. Hereinafter, information indicating this determination result is referred to as “control method information.”

Uplink scheduler 11 notifies uplink control section 21 of the resource allocation information and the control method information.

Uplink control section 21 converts the resource allocation information and the control method information to an uplink control signal and sends the uplink control signal to first radio transmitting section 31 and second radio transmitting section 41.

First radio transmitting section 31 and second radio transmitting section 41 send a downlink radio signal including the user data and the uplink control signal to radio terminal apparatus 100.

In FIG. 7, radio terminal apparatus 100 includes first radio receiving section 50, second radio receiving section 60, and control signal receiving section 70 in addition to the configuration shown in FIG. 3.

First radio receiving section 50 and second radio receiving section 60 receive a downlink radio signal from base station apparatus 101 and send the downlink radio signal to control signal receiving section 70.

Control signal receiving section 70 extracts an uplink control signal from the downlink radio signal and stores the signal in memory 10 as a control parameter.

Transmission control section 20 performs the following operation in addition to the operation described in Embodiments 1 and 2. That is, transmission control section 20 determines whether to control the bandwidth, control transmission power or control both the bandwidth and transmission power based on the control method information included in the uplink control signal. Transmission control section 20 executes the determined control method.

In the above-described control method, the operation of controlling transmission power is one of the operation of adjusting transmission power described in Embodiment 1 and the operation of adjusting transmission power described in Embodiment 2. On the other hand, operation of controlling a bandwidth will be described below.

<Control of Bandwidth>

Uplink scheduler 11 determines which frequency band (RB) in which time band (subframe)/system band should be used for transmission (radio resources). This determination is made based on signal quality of SRS (Sounding Reference Signal) transmitted by radio terminal apparatus 100 and the amount of transmission data requested by radio terminal apparatus 100. Uplink scheduler 11 then transmits a control signal for enabling communication to radio terminal apparatus 100.

On the other hand, radio terminal apparatus 100 controls the transmission power of radio terminal apparatus 100 so that power spectral densities at radio receiving sections 51 and 61 are substantially equal in order to prevent interference of transmission signals between radio receiving sections 51 and 61 of base station apparatus 101, and other radio terminal apparatus. Therefore, the bandwidth is substantially proportional to the transmission power.

Thus, base station apparatus 101 controls the bandwidth of radio terminal apparatus 100 (e.g., narrows b1 or b2 shown in FIG. 1), thereby consequently controlling transmission power. Thus, even when radio terminal apparatus 100 controls only the bandwidth, this is equivalent to controlling transmission power, and it is thereby possible to achieve effects similar to those of Embodiments 1 and 2. Note that by directly reducing the transmission power of each carrier of CC in addition to indirect control of transmission power by control of the bandwidth of the CC, transmission power of the CC may be further reduced.

Radio terminal apparatus 100 recalculates the transmission power based on the controlled bandwidth, further adjusts the transmission power described in Embodiment 1 or 2, and can thereby achieve both bandwidth control and transmission power control.

Thus, base station apparatus 101 of the present embodiment selects a control method for suppressing IMD according to channel quality and the amount of transmission data (bandwidth control and/or transmission power control) and instructs radio terminal apparatus 100 to execute the control method. Radio terminal apparatus 100 of the present embodiment executes the control method selected by base station apparatus 101 and performs radio transmission. In this way, the radio communication system of the present embodiment can effectively reduce the interference while suppressing the influence of the uplink transmission performance to the minimum.

The following control method may also be used as another example of the control method for suppressing IMD. That is, when there is a sufficient margin of the uplink channel quality and traffic, uplink scheduler 11 of base station apparatus 101 increases the allocated bandwidth of the CC within a range in which transmission power of the CC located in the vicinity of IMD to be suppressed does not increase and performs control so as to reduce a power spectral density of the CC. Such control causes the bandwidth of IMD to expand and causes the power density of IMD to decrease, and can thereby more effectively suppress interference.

Uplink scheduler 11 of base station apparatus 101 may instruct radio terminal apparatus 100 to perform both or one of control to decrease a power spectral density of the CC located in the vicinity of IMD to be suppressed and control to decrease transmission power of the CC. As the control to decrease transmission power of the CC instructed by uplink scheduler 11, there can be control to decrease power of each carrier making up the CC and control to decrease the bandwidth without changing the power spectral density of the CC. The former corresponds to “control of transmission power” of the present embodiment and the latter corresponds to “control of bandwidth” of the present embodiment.

### Variations of Embodiments

The embodiments of the present invention have been described so far, but the above description is an example only, and various modifications can be made thereto. Hereinafter, variations of the embodiments will be described.

In foregoing Embodiments 1 to 3, the present invention employs a hardware configuration by way of example, but the present invention may also be achieved by software in cooperation with hardware.

The disclosure of Japanese Patent Application No. 2013-006835, filed on Jan. 18, 2013, including the specification, drawings and abstract is incorporated herein by reference in its entirety.

### INDUSTRIAL APPLICABILITY

The present invention is useful as a terminal apparatus, a base station apparatus, a radio communication system, a radio communication method, and a radio communication program that perform communication simultaneously using a plurality of modulated waves with different frequencies.

### REFERENCE SIGNS LIST

10 Memory
11 Uplink scheduler
20 Transmission control section
21 Uplink control section
30, 31 First radio transmitting section
40, 41 Second radio transmitting section
50, 51 First radio receiving section
60, 61 Second radio receiving section
70 Control signal receiving section
71 Uplink quality estimation section
100 Radio terminal apparatus
101 Base station apparatus
201 First IQ transmitting section
202 Second IQ transmitting section
203 First transmission circuit setting section
204 Second transmission circuit setting section
205 Power difference determining section
206 IMD frequency calculation section
207 Protected-band determining section
208 Relaxation-value calculation section
209 Reduction-value searching section
210 Reduction-value relaxing section
211 Transmission power adjustment section

1. A radio terminal apparatus that simultaneously transmits a plurality of modulated waves with different frequencies, the radio terminal apparatus comprising
a transmission power adjustment section that adjusts transmission power of a modulated wave located in a vicinity of inter-modulation distortion included in a predetermined protected band such that the transmission power is smaller than transmission power of another modulated wave.

2. The radio terminal apparatus according to claim 1, further comprising:
a power difference determining section that determines a power difference between transmission power of a first modulated wave and transmission power of a second modulated wave;
an inter-modulation distortion frequency calculation section that calculates a frequency of inter-modulation distortion included in the protected band;
a protected-band determining section that determines, in a vicinity of which of the first modulated wave or the second modulated wave, the inter-modulation distortion included in the protected band is located;
a relaxation-value calculation section that calculates a relaxation value based on the power difference, upon determining, based on the determination result of the power difference determining section and the determination result of the protected-band determining section, that transmission power of the first modulated wave or the second modulated wave located in the vicinity of inter-modulation distortion included in the protected band is lower than transmission power of the other one of the first modulated wave and the second modulated wave; and
a reduction-value relaxing section that subtracts the relaxation value from a predetermined reduction value based on respective transmission conditions of the first modulated wave and the second modulated wave, thereby calculating a relaxed reduction value, wherein:
the transmission power adjustment section adjusts predetermined maximum transmission power based on the relaxed reduction value, thereby calculating a limit value,
calculates total transmission power by adding up the transmission power of the first modulated wave and the transmission power of the second modulated wave,
calculates an excess value which is a value by which the total transmission power exceeds the limit value, and
subtracts the excess value from the transmission power of the first modulated wave and the transmission power of the second modulated wave.

3. The radio terminal apparatus according to claim 2, wherein the relaxation-value calculation section determines the relaxation value to be 0, when the frequency of the inter-modulation distortion is not included in the protected band.

4. The radio terminal apparatus according to claim 2, wherein upon determining that the transmission power of the modulated wave located in the vicinity of inter-modulation distortion included in the protected band is not lower than the transmission power of the other modulated wave, the relaxation-value calculation section determines the relaxation value to be 0.

5. The radio terminal apparatus according to claim 2, wherein, when the result of subtracting the relaxation value from the predetermined reduction value becomes a negative number, the reduction-value relaxing section determines the relaxed reduction value to be 0.

6. The radio terminal apparatus according to claim 2, wherein:
the protected-band determining section further determines a degree of inter-modulation distortion included in the protected band, and
upon determining that the transmission power of the modulated wave located in the vicinity of inter-modulation distortion included in the protected band is lower than the transmission power of the other modulated wave, the relaxation-value calculation section calculates the relaxation value based on the power difference and the degree.

7. The radio terminal apparatus according to claim 1, further comprising:
an inter-modulation distortion frequency calculation section that calculates a frequency of inter-modulation distortion included in the protected band; and
a protected-band determining section that determines in the vicinity of which of first modulated wave or second modulated wave, the inter-modulation distortion included in the protected band is located, wherein:
the transmission power adjustment section recognizes, based on the determination result of the protected-band determining section, which of the first modulated wave or the second modulated wave is located in the vicinity of inter-modulation distortion included in the protected band,
adjusts predetermined maximum transmission power using a predetermined reduction value based on respective transmission conditions of the first modulated wave and the second modulated wave, thereby calculating a limit value,
adds up the transmission power of the first modulated wave and the transmission power of the second modulated wave, thereby calculating total transmission power,
calculates an excess value by which the total transmission power exceeds the limit value,
calculates two different reduction amounts based on the excess value so that the transmission power of the modulated wave located in the vicinity of inter-modulation distortion included in the protected band is reduced more than the transmission power of the other modulated wave, and
subtracts the reduction amounts respectively from both or one of the transmission power of the first modulated wave and the transmission power of the second modulated wave.

8. The radio terminal apparatus according to claim 7, wherein the transmission power adjustment section adds a predetermined offset to the reduction amounts.

9. The radio terminal apparatus according to claim 7, wherein the transmission power adjustment section selects as the predetermined reduction value, a reduction value with which the transmission power of the first modulated wave located in the vicinity of inter-modulation distortion included in the protected band or the second modulated wave is reduced more than the transmission power of the other modulated wave.

10. The radio terminal apparatus according to claim 1, wherein the radio terminal apparatus performs control based on an instruction to control a bandwidth, control transmission power or both the bandwidth and transmission power received from a base station apparatus.

11. A base station apparatus that performs communication with a radio terminal apparatus that simultaneously transmits a plurality of modulated waves with different frequencies, wherein the base station apparatus instructs the radio terminal apparatus to perform control of reducing at least one of transmission power of a modulated wave located in a vicinity of inter-modulation distortion included in a predetermined protected band and a power spectral density of the modulated wave in order to suppress inter-modulation distortion.

12. The base station apparatus according to claim 11, wherein:
the modulated wave is transmitted using a plurality of carriers, and
when instructing control including reducing the transmission power, the base station apparatus includes, in the control to be instructed to the radio terminal apparatus, control of reducing transmission power of each carrier used for transmission of a modulated wave located in the vicinity of inter-modulation distortion included in the predetermined protected band.

13. The base station apparatus according to claim 11, wherein, when instructing control including reducing the transmission power, the base station apparatus includes, in the control to be instructed to the radio terminal apparatus, control of reducing a bandwidth of a modulated wave located in the vicinity of inter-modulation distortion included in the predetermined protected band.

14. The base station apparatus according to claim 11, wherein, when instructing control including reducing the power spectral density, the base station apparatus includes, in the control to be instructed to the radio terminal apparatus, control of increasing a bandwidth used for transmission of the modulated wave without increasing transmission power of a modulated wave located in the vicinity of inter-modulation distortion included in the predetermined protected band.

15. A radio terminal apparatus that simultaneously transmits a plurality of modulated waves with different frequencies to the base station apparatus according to claim 11, wherein the radio terminal apparatus performs control of reducing at least one of transmission power of a modulated wave located in the vicinity of inter-modulation distortion included in a predetermined protected band and a power spectral density of the modulated wave in order to suppress inter-modulation distortion based on the instruction received from the base station apparatus.

16. A radio communication control method for simultaneously transmitting a plurality of modulated waves with different frequencies, the radio communication control method comprising adjusting transmission power of a modulated wave located in a vicinity of inter-modulation distortion included in a predetermined protected band such that the transmission power is smaller than transmission power of another modulated wave.
